(19) United States
(12) Patent Application Publication
(10) Pub. No.: US 2024/0111495 A1
(43) Pub. Date: Apr. 4, 2024

(54) OPERATIONAL AND EXECUTABLE REQUIREMENTS ASSISTANT

(71) Applicant: JPMorgan Chase Bank, N.A., New York, NY (US)

(72) Inventors: Satyama BOINA, Morganville, NJ (US); Rajanikanth KUNCHALA, Powell, OH (US)

(73) Assignee: JPMorgan Chase Bank, N.A., New York, NY (US)

(21) Appl. No.: 17/959,755

(22) Filed: Oct. 4, 2022

(51) Int. Cl. G06F 8/33; G06F 8/70; G06F 40/40

(52) U.S. Cl. CPC G06F 8/33; G06F 8/70; G06F 40/40

(57) ABSTRACT

A method and a system for using a machine learning model to provide a virtual assistant for automatically guiding and assessing operational and non-functional requirements of an application are provided. The method includes: receiving information that relates to an application; generating one or more questions that relates to the application based on the received information; receiving responses to the questions; measuring one or more metrics that relate to non-functional requirements of the application; and determining whether a non-functional requirement of the application is satisfied based on the received information, the received responses, and the metrics. The questions are generated by executing a machine learning algorithm that is trained by using historical data that relates to non-functional requirements of other similar applications.

### BACKGROUND

### 1. Field of the Disclosure

This technology generally relates to methods and systems for using a machine learning model to provide a virtual assistant for automatically guiding and assessing operational and non-functional requirements of an application.

### 2. Background Information

Conventionally, the handling of non-functional requirements of an application requires software developers and application owners to study various documents and understand and evaluate the configuration needs of the application, based on their respective levels of experience and performance test results executed at the time of implementation of the application. Subject Matter Experts (SMEs) who have had experience with non-functional requirements and who have knowledge relating to Site Resiliency Engineering (SRE) are able to evaluate the needs of a particular application.

Typically, there are many knowledge base materials available to developers, but the volume of these materials often causes developers to become lost in searching for appropriate guidelines for their specific applications. In many instances, even after running multiple performance and resiliency tests during the implementation phase, non-functional requirements are handled after going into production in a reactive manner by learning from issues that subsequently arise.

Existing knowledge base materials provide information that relates to any particular functional area. However, studying such materials and evaluating with a human eye is a cumbersome process, with respect to determining whether an application satisfies all requirements. In addition, experienced SME/SRE personnel are more capable of handling the task in an efficient manner than less experienced SME/SRE personnel, and as a result, knowledge gap issues often arise when a key SME/SRE person leaves a critical project.

There are tools that provide multiple metrics for a current infrastructure state, memory utilization, central processing unit (CPU) utilization, and transactions per second (TPS) metrics. Existing metrics are generally obtained through manual evaluations in a reactive approach, and thresholds are configured based on common metrics obtained from different applications.

Accordingly, there is a need for a mechanism for automatically guiding and assessing operational and non-functional requirements of an application.

### SUMMARY

The present disclosure, through one or more of its various aspects, embodiments, and/or specific features or sub-components, provides, inter alia, various systems, servers, devices, methods, media, programs, and platforms for using a machine learning model to provide a virtual assistant for automatically guiding and assessing operational and non-functional requirements of an application.

According to an aspect of the present disclosure, a method for assessing non-functional requirements of an application is provided. The method is implemented by at least one processor. The method includes: receiving, by the at least one processor, first information that relates to a first application; generating, by the at least one processor based on the first information, at least one first question that relates to the first application; receiving, by the at least one processor, a response to the at least one first question; measuring, by the at least one processor, at least one metric that relates to the first application; and determining, by the at least one processor based on the first information, the received response, and the at least one metric, whether a non-functional requirement of the first application is satisfied.

The generating of the at least one first question may include applying a first algorithm that implements a machine learning technique. The first algorithm may be trained by using historical data that relates to non-functional requirements of at least one second application. The first algorithm may use the first information as an input and may generate an output that includes the at least one first question.

The method may further include generating, based on the response to the at least one first question, at least one second question.

The generating of the at least one second question may include using a term frequency-inverse document frequency (TF-IDF) technique to analyze the response to the at least one first question.

The first algorithm may be trained by using a Bidirectional Encoder Representations from Transformers (BERT) model.

The method may further include: when the non-functional requirement of the first application is determined as not being satisfied, identifying a problem that relates to a failure to satisfy the non-functional requirement; and generating a proposed resolution to the identified problem.

The problem may include at least one from among a power outage, a server outage, and a network malfunction.

The method may further include displaying, via a graphical user interface, the at least one first question.

The at least one metric may include at least one from among a first metric that relates to an infrastructure state of the first application, a second metric that relates to a memory utilization of the first application, a third metric that relates to a central processing unit (CPU) utilization of the first application, and a fourth metric that relates to a number of transactions per second associated with the first application.

According to another exemplary embodiment, a computing apparatus for assessing non-functional requirements of an application is provided. The computing apparatus includes a processor; a memory; a display; and a communication interface coupled to each of the processor, the memory, and the display. The processor is configured to: receive, via the communication interface, first information that relates to a first application; generate, based on the first information, at least one first question that relates to the first application; receive, via the communication interface, a response to the at least one first question; measure, by the at least one processor, at least one metric that relates to the first application; and determine, based on the first information, the received response, and the at least one metric, whether a non-functional requirement of the first application is satisfied.

The processor may be further configured to generate the at least one first question by applying a first algorithm that implements a machine learning technique. The first algorithm may be trained by using historical data that relates to non-functional requirements of at least one second application. The first algorithm may use the first information as an input and may generate an output that includes the at least one first question.

The processor may be further configured to generate, based on the response to the at least one first question, at least one second question.

The processor may be further configured to generate the at least one second question by using a term frequency-inverse document frequency (TF-IDF) technique to analyze the response to the at least one first question.

The first algorithm may be trained by using a Bidirectional Encoder Representations from Transformers (BERT) model.

The processor may be further configured to: when the non-functional requirement of the first application is determined as not being satisfied, identify a problem that relates to a failure to satisfy the non-functional requirement; and generate a proposed resolution to the identified problem.

The problem may include at least one from among a power outage, a server outage, and a network malfunction.

The processor may be further configured to cause the display to display, via a graphical user interface, the at least one first question.

The at least one metric may include at least one from among a first metric that relates to an infrastructure state of the first application, a second metric that relates to a memory utilization of the first application, a third metric that relates to a central processing unit (CPU) utilization of the first application, and a fourth metric that relates to a number of transactions per second associated with the first application.

According to yet another exemplary embodiment, a non-transitory computer readable storage medium storing instructions for assessing non-functional requirements of an application is provided. The storage medium includes executable code which, when executed by a processor, causes the processor to: receive first information that relates to a first application; generate, based on the first information, at least one first question that relates to the first application; receive a response to the at least one first question; measure at least one metric that relates to the first application; and determine, based on the first information, the received response, and the at least one metric, whether a non-functional requirement of the first application is satisfied.

When executed by the processor, the executable code may be further configured to generate the at least one first question by applying a first algorithm that implements a machine learning technique. The first algorithm may be trained by using historical data that relates to non-functional requirements of at least one second application. The first algorithm may use the first information as an input and may generate an output that includes the at least one first question.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using a machine learning model to provide a virtual assistant for automatically guiding and assessing operational and non-functional requirements of an application.

FIG. 4 is a flowchart of an exemplary process for implementing a method for using a machine learning model to provide a virtual assistant for automatically guiding and assessing operational and non-functional requirements of an application.

FIG. 5 is a block diagram that illustrates components of a system that is configured for using a machine learning model to provide a virtual assistant for automatically guiding and assessing operational and non-functional requirements of an application, according to an exemplary embodiment.

FIG. 6 is an illustration of a graphical user interface of a system that is configured for using a machine learning model to provide a virtual assistant for automatically guiding and assessing operational and non-functional requirements of an application, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

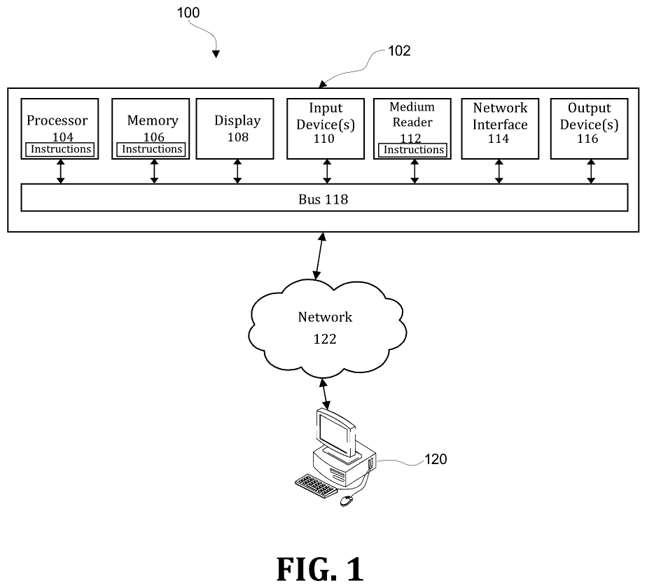

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using a machine learning model to provide a virtual assistant for automatically guiding and assessing operational and non-functional requirements of an application.

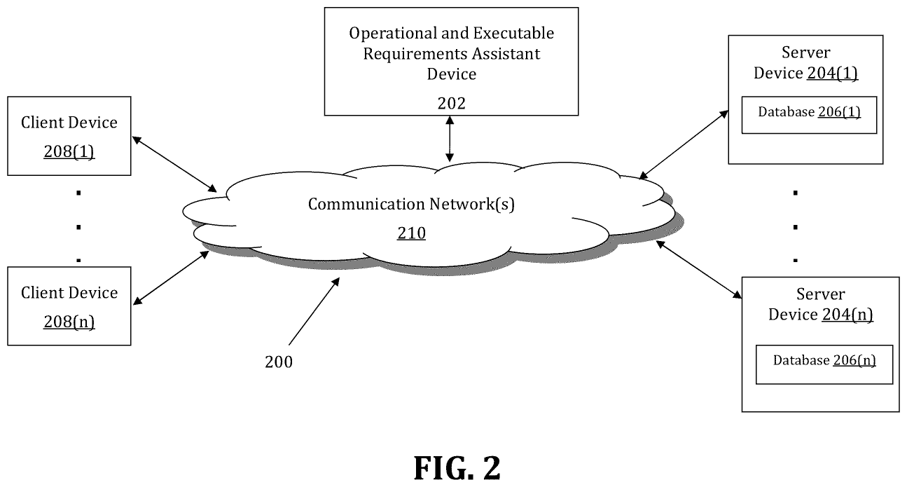

Referring to FIG. 2, a schematic of an exemplary network environment 200 for implementing a method for using a machine learning model to provide a virtual assistant for automatically guiding and assessing operational and non-functional requirements of an application is illustrated. In an exemplary embodiment, the method is executable on any networked computer platform, such as, for example, a personal computer (PC).

The method for using a machine learning model to provide a virtual assistant for automatically guiding and assessing operational and non-functional requirements of an application may be implemented by an OPerational and Executable Requirements Assistant (OPERA) device 202. The OPERA device 202 may be the same or similar to the computer system 102 as described with respect to FIG. 1. The OPERA device 202 may store one or more applications that can include executable instructions that, when executed by the OPERA device 202, cause the OPERA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OPERA device 202 itself, may be located in virtual server(s) running in a cloud-based computing environment rather than being tied to one or more specific physical network computing devices. Also, the application(s) may be running in one or more virtual machines (VMs) executing on the OPERA device 202. Additionally, in one or more embodiments of this technology, virtual machine(s) running on the OPERA device 202 may be managed or supervised by a hypervisor.

In the network environment 200 of FIG. 2, the OPERA device 202 is coupled to a plurality of server devices 204(1)-204(n) that hosts a plurality of databases 206(1)-206(n), and also to a plurality of client devices 208(1)-208(n) via communication network(s) 210. A communication interface of the OPERA device 202, such as the network interface 114 of the computer system 102 of FIG. 1, operatively couples and communicates between the OPERA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OPERA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OPERA devices that efficiently implement a method for using a machine learning model to provide a virtual assistant for automatically guiding and assessing operational and non-functional requirements of an application.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OPERA device 202 may be a standalone device or integrated with one or more other devices or apparatuses, such as one or more of the server devices 204(1)-204(n), for example. In one particular example, the OPERA device 202 may include or be hosted by one of the server devices 204(1)-204(n), and other arrangements are also possible. Moreover, one or more of the devices of the OPERA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OPERA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to application-specific non-functional requirements and information that relates to statistics and analytical metrics for non-functional requirements.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OPERA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OPERA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OPERA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OPERA device 202, the server devices 204(1)-204(n), or the client devices 208(1)-208(n), for example, may be configured to operate as virtual instances on the same physical machine. In other words, one or more of the OPERA device 202, the server devices 204(1)-204(n), or the client devices 208(1)-208(n) may operate on the same physical device rather than as separate devices communicating through communication network(s) 210. Additionally, there may be more or fewer OPERA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

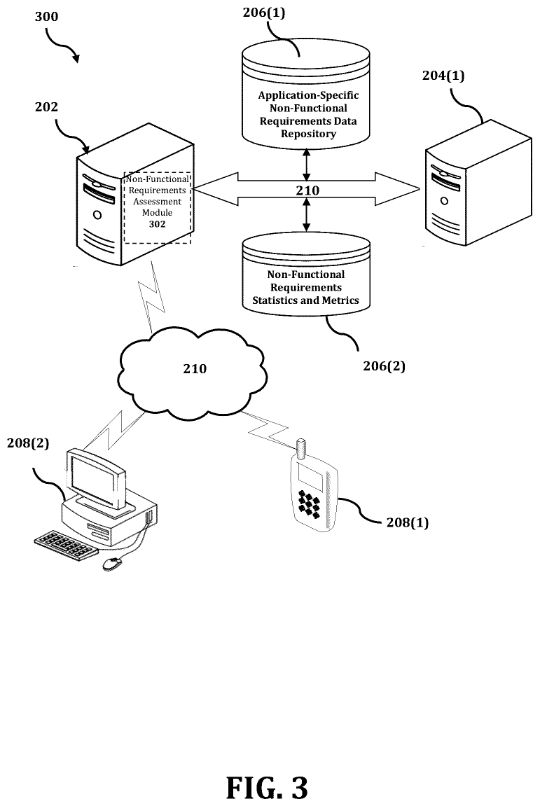

The OPERA device 202 is described and illustrated in FIG. 3 as including a non-functional requirements assessment module 302, although it may include other rules, policies, modules, databases, or applications, for example. As will be described below, the non-functional requirements assessment module 302 is configured to implement a method for using a machine learning model to provide a virtual assistant for automatically guiding and assessing operational and non-functional requirements of an application.

An exemplary process 300 for implementing a mechanism for using a machine learning model to provide a virtual assistant for automatically guiding and assessing operational and non-functional requirements of an application by utilizing the network environment of FIG. 2 is illustrated as being executed in FIG. 3. Specifically, a first client device 208(1) and a second client device 208(2) are illustrated as being in communication with OPERA device 202. In this regard, the first client device 208(1) and the second client device 208(2) may be “clients” of the OPERA device 202 and are described herein as such. Nevertheless, it is to be known and understood that the first client device 208(1) and/or the second client device 208(2) need not necessarily be “clients” of the OPERA device 202, or any entity described in association therewith herein. Any additional or alternative relationship may exist between either or both of the first client device 208(1) and the second client device 208(2) and the OPERA device 202, or no relationship may exist.

Further, OPERA device 202 is illustrated as being able to access an application-specific non-functional requirements data repository 206(1) and a non-functional requirements statistics and metrics database 206(2). The non-functional requirements assessment module 302 may be configured to access these databases for implementing a method for using a machine learning model to provide a virtual assistant for automatically guiding and assessing operational and non-functional requirements of an application.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OPERA device 202 via broadband or cellular communication. Of course, these embodiments are merely exemplary and are not limiting or exhaustive.

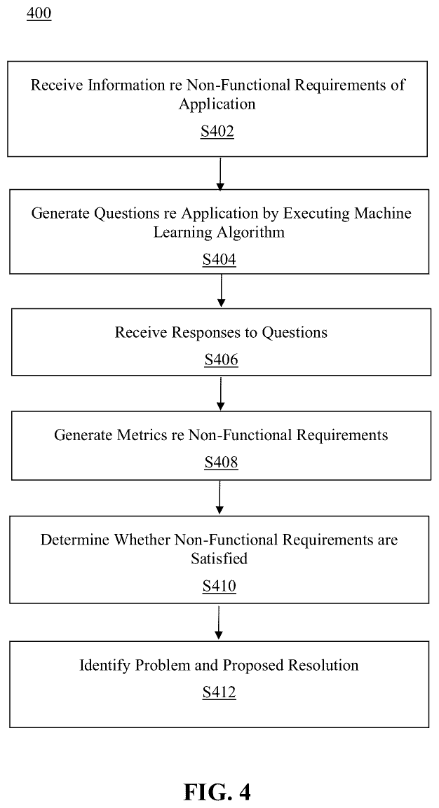

Upon being started, the non-functional requirements assessment module 302 executes a process for using a machine learning model to provide a virtual assistant for automatically guiding and assessing operational and non-functional requirements of an application. An exemplary process for using a machine learning model to provide a virtual assistant for automatically guiding and assessing operational and non-functional requirements of an application is generally indicated at flowchart 400 in FIG. 4.

In process 400 of FIG. 4, at step S402, the non-functional requirements assessment module 302 receives information about an application. In an exemplary embodiment, the information relates to one or more non-functional requirements of the application, such as, for example, infrastructure requirements, platform requirements, hardware component requirements, memory requirements, CPU requirements, and throughput data rate requirements.

At step S404, the non-functional requirements assessment module 302 generates a first set of questions based on the information received in step S402. In an exemplary embodiment, the generation of the questions is performed by applying an algorithm that implements a machine learning (ML) technique to the information received in step S402. In an exemplary embodiment, the ML algorithm is trained by using historical information that relates to other similar applications, and the ML algorithm may also be trained by using a Bidirectional Encoder Representations from Transformers (BERT) model. The ML algorithm uses the received information as an input and generates the first set of questions as an output.

At step S406, the non-functional requirements assessment module 302 receives responses to the questions generated in step S404. In an exemplary embodiment, the questions are displayed on a display via a graphical user interface (GUI) that facilitates user interactivity. For example, each question that is displayed via the GUI may be accompanied by a prompt that enables a user to type an answer to the question.

In an exemplary embodiment, the non-functional requirements assessment module 302 may use the responses to the questions to generate a second set of questions that function as a follow-up to the first set of questions and answers. In an exemplary embodiment, the ML algorithm uses a natural language processing (NLP) technique, such as, for example, a Term Frequency-Inverse Document Frequency (TF-IDF) technique, with respect to the responses to the first questions, in order to generate the second set of questions. In this aspect, steps S404 and S406 may be repeated any number of times until the non-functional requirements assessment module 302 determines that sufficient information has been received.

At step S408, the non-functional requirements assessment module 302 generates metrics that relate to one or more non-functional requirements of the application. In an exemplary embodiment, the metrics may include any one or more of a first metric that relates to an infrastructure state of the application, a second metric that relates to a memory utilization of the application, a third metric that relates to a central processing unit (CPU) utilization of the application, and a fourth metric that relates to a number of transactions per second associated with the application.

At step S410, the non-functional requirements assessment module 302 determines whether the non-functional requirements of the application are satisfied. Then, at step S412, when a determination is made that at least one non-functional requirement is not being satisfied, the non-functional requirements assessment module 302 identifies a potential problem that may be causing the failure to satisfy the requirement, and also generates a proposed resolution to the identified problem. For example, the potential problem may include any one or more of a power outage, a server outage, a network malfunction, and/or any other type of problem that is associated with shortfalls with respect to non-functional requirements of applications.

In an exemplary embodiment, Operational and Executable Requirements Assistant (OPERA) is an automated evaluation tool to guide and assess operational or non-functional requirements (NFRs) for an application. OPERA learns about an upcoming or existing project based on user inputs and from similar projects which are already in production. OPERA assists by gathering human recommendations and by analyzing metrics that are measurable.

In an exemplary embodiment, OPERA is able to learn from production incidents and/or from changes in an application by ingesting training data. OPERA is designed to help meet a demand for a site resiliency expert (SRE) or a subject matter expert (SME) resource for any particular development team. In addition, based on information that is gathered from root cause analysis of production issues that occur across a platform, the OPERA features are extendible to notify existing application owners which may be at risk.

In an exemplary embodiment, OPERA is designed to assist in building and maintaining applications with accurate configurations and continuous monitoring by 1) improving efficiency in assessing and implementing NFRs; 2) reducing time to market and cost by providing the assistance of an automated engine for NFRs; and 3) maximizing value by combining human intelligence with historical production metrics.

In an exemplary embodiment, OPERA uses a machine learning (ML) model that is trained with a combination of human intelligence and historic metrics of similar applications. Users and developers are able to interact with an automated assistant bot to submit answers to questions that relate to NFRs. The questions are automatically adjusted and generated in real time based on responses from a user or developer. OPERA provides guidance and evaluation of various settings to effectively manage an application in production. OPERA features are extendible, with features such as periodic screenings and scheduled jobs which can check metrics by taking inputs from various measurement tools.

In an exemplary embodiment, a primary objective of the OPERA tool is to assist software developers in assessing configurations and evaluating various test results required for NFRs, such as data center resiliency, memory allocation, and various other types of NFRs. In this aspect, an intelligent bot provides assistance in the evaluation of NFR requirements and configurations by providing an experience that is similar to a human being that is performing the same job with an SME/SRE skill set. The OPERA tool captures developer inputs and inputs from automated application programming interfaces (APIs) and then generates inquiries or questions by using a trained ML model. Question and respective answers are then evaluated against available historical data in order to generate feedback that is provided immediately to the developer in an interactive manner.

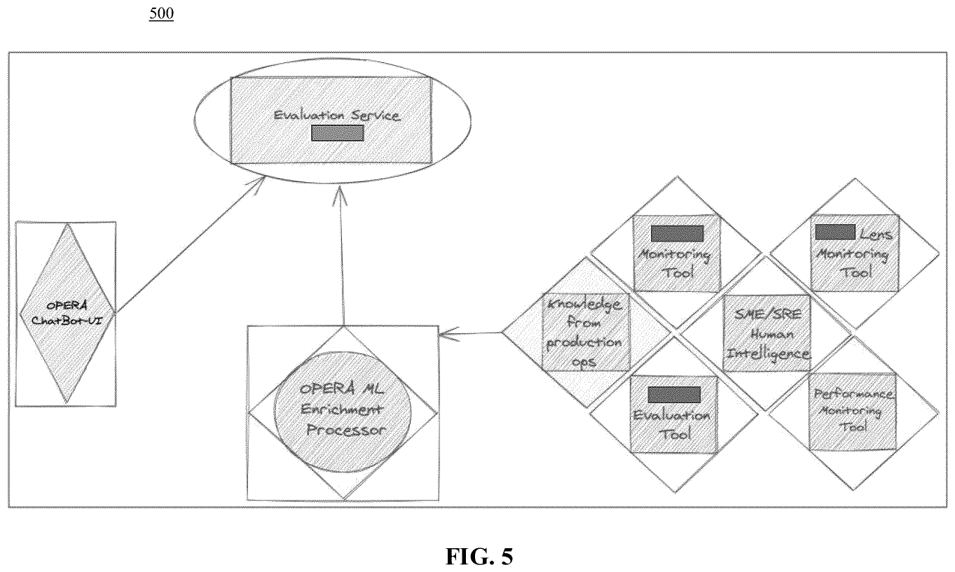

FIG. 5 is a block diagram 500 that illustrates components of a system that is configured for using a machine learning model to provide a virtual assistant for automatically guiding and assessing operational and non-functional requirements of an application, according to an exemplary embodiment. As shown in FIG. 5, the system includes a Chatbot user interface (UI), an evaluation service, and an ML model enrichment processor. The Chatbot UI interacts with the evaluation service, which runs based on the ML model, which is trained with suitable data. The enrichment processor processes ingested data from various tools and platforms, such as, for example, monitoring tools, a performance monitoring tool, SME/SRE human intelligence, an evaluation tool, and knowledge from production operations.

Chatbot Virtual Assistant: In an exemplary embodiment, the virtual assistant is a chat bot application that is designed to interact with a developer and/or an application owner. Many non-functional requirements are relatively complex, and as a result, the ability to interact with the virtual assistant benefits a developer by conducting a conversation. In this manner, the virtual assistant provides flexibility to inquire about an application and to provide suggestions and/or guidance to a developer to facilitate knowledge retrieval.

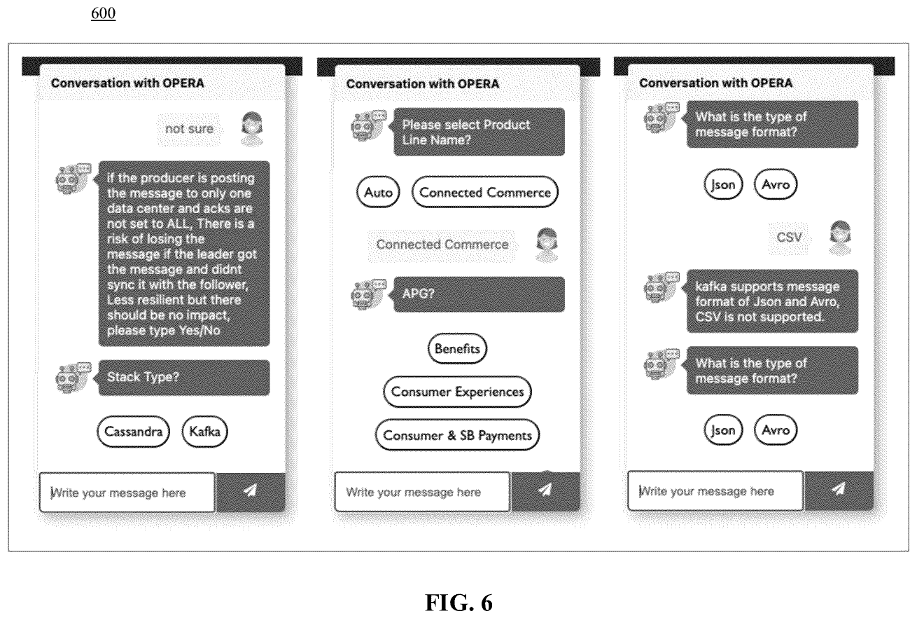

FIG. 6 is an illustration 600 of a graphical user interface of a system that is configured for using a machine learning model to provide a virtual assistant for automatically guiding and assessing operational and non-functional requirements of an application, according to an exemplary embodiment. As illustrated in FIG. 6, the virtual assistant may be created by using a ReactJS framework in order to provide flexibility, performance, and usability. In an exemplary embodiment, the virtual assistant provides a feature of presenting form fields directly in a user interface, which may be more intuitive for the developer.

Evaluation Service: In an exemplary embodiment, the evaluation service provides operations that are required for assessment of developer questions that are related to the application. The evaluation service first asks a series of preliminary questions in order to learn about the application to be evaluated. The virtual assistant learns about the knowledge level of the developer, based on the responses to the preliminary questions, and then guides the developer as to which areas are worthy of further attention.

In an exemplary embodiment, the question-and-answer capability uses natural language processing (NLP) techniques. An initial version of the implementation questions is answered based on text classification by using a Term Frequency-Inverse Document Frequency (TF-IDF) technique.

In an exemplary embodiment, a Bidirectional Encoder Representations from Transformers (BERT) model may be used to determine a full context of a word by examining the words that come before and after the critical concept words. This type of model is especially useful for understanding an intent that underlies a query. Because of its bidirectionality, the BERT model has a relatively deep sense of language content and flow.

ML Model Enrichment Processor: In an exemplary embodiment, SME and SRE human inputs are usable for training the model, together with historical production metrics. Model enrichment may be performed manually or as an automated process. In an exemplary embodiment, an automated process for model enrichment uses standard online libraries to do web scrapping of existing documents and web sites for the NFR content, and for cleaning and preparing data which is then fed into NLP models.

Accordingly, with this technology, an optimized process for using a machine learning model to provide a virtual assistant for automatically guiding and assessing operational and non-functional requirements of an application is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for assessing non-functional requirements of an application, the method being implemented by at least one processor, the method comprising:
receiving, by the at least one processor, first information that relates to a first application;
generating, by the at least one processor based on the first information, at least one first question that relates to the first application;
receiving, by the at least one processor, a response to the at least one first question;
measuring, by the at least one processor, at least one metric that relates to the first application; and
determining, by the at least one processor based on the first information, the received response, and the at least one metric, whether a non-functional requirement of the first application is satisfied.

2. The method of claim 1, wherein:
the generating of the at least one first question comprises applying a first algorithm that implements a machine learning technique;
the first algorithm is trained by using historical data that relates to non-functional requirements of at least one second application; and
the first algorithm uses the first information as an input and generates an output that includes the at least one first question.

3. The method of claim 2, further comprising generating, based on the response to the at least one first question, at least one second question.

4. The method of claim 3, wherein the generating of the at least one second question comprises using a term frequency-inverse document frequency (TF-IDF) technique to analyze the response to the at least one first question.

5. The method of claim 2, wherein the first algorithm is trained by using a Bidirectional Encoder Representations from Transformers (BERT) model.

6. The method of claim 1, further comprising:
when the non-functional requirement of the first application is determined as not being satisfied, identifying a problem that relates to a failure to satisfy the non-functional requirement; and
generating a proposed resolution to the identified problem.

7. The method of claim 6, wherein the problem includes at least one from among a power outage, a server outage, and a network malfunction.

8. The method of claim 1, further comprising displaying, via a graphical user interface, the at least one first question.

9. The method of claim 1, wherein the at least one metric includes at least one from among a first metric that relates to an infrastructure state of the first application, a second metric that relates to a memory utilization of the first application, a third metric that relates to a central processing unit (CPU) utilization of the first application, and a fourth metric that relates to a number of transactions per second associated with the first application.

10. A computing apparatus for assessing non-functional requirements of an application, the computing apparatus comprising:
a processor;
a memory;
a display; and
a communication interface coupled to each of the processor, the memory, and the display,
wherein the processor is configured to:
receive, via the communication interface, first information that relates to a first application;
generate, based on the first information, at least one first question that relates to the first application;
receive, via the communication interface, a response to the at least one first question;
measure, by the at least one processor, at least one metric that relates to the first application; and
determine, based on the first information, the received response, and the at least one metric, whether a non-functional requirement of the first application is satisfied.

11. The computing apparatus of claim 10, wherein the processor is further configured to generate the at least one first question by applying a first algorithm that implements a machine learning technique; and
wherein the first algorithm is trained by using historical data that relates to non-functional requirements of at least one second application; and
wherein the first algorithm uses the first information as an input and generates an output that includes the at least one first question.

12. The computing apparatus of claim 11, wherein the processor is further configured to generate, based on the response to the at least one first question, at least one second question.

13. The computing apparatus of claim 12, wherein the processor is further configured to generate the at least one second question by using a term frequency-inverse document frequency (TF-IDF) technique to analyze the response to the at least one first question.

14. The computing apparatus of claim 11, wherein the first algorithm is trained by using a Bidirectional Encoder Representations from Transformers (BERT) model.

15. The computing apparatus of claim 10, wherein the processor is further configured to:
when the non-functional requirement of the first application is determined as not being satisfied, identify a problem that relates to a failure to satisfy the non-functional requirement; and
generate a proposed resolution to the identified problem.

16. The computing apparatus of claim 15, wherein the problem includes at least one from among a power outage, a server outage, and a network malfunction.

17. The computing apparatus of claim 10, wherein the processor is further configured to cause the display to display, via a graphical user interface, the at least one first question.

18. The computing apparatus of claim 10, wherein the at least one metric includes at least one from among a first metric that relates to an infrastructure state of the first application, a second metric that relates to a memory utilization of the first application, a third metric that relates to a central processing unit (CPU) utilization of the first application, and a fourth metric that relates to a number of transactions per second associated with the first application.

19. A non-transitory computer readable storage medium storing instructions for assessing non-functional requirements of an application, the storage medium comprising executable code which, when executed by a processor, causes the processor to:
receive first information that relates to a first application;
generate, based on the first information, at least one first question that relates to the first application;
receive a response to the at least one first question;
measure at least one metric that relates to the first application; and
determine, based on the first information, the received response, and the at least one metric, whether a non-functional requirement of the first application is satisfied.

20. The storage medium of claim 19, wherein when executed by the processor, the executable code is further configured to generate the at least one first question by applying a first algorithm that implements a machine learning technique; and
wherein the first algorithm is trained by using historical data that relates to non-functional requirements of at least one second application; and
wherein the first algorithm uses the first information as an input and generates an output that includes the at least one first question.
